(19) United States
(12) Patent Application Publication
(10) Pub. No.: US 2010/0026826 A1
(43) Pub. Date: Feb. 4, 2010

(54) APPARATUS FOR PROTECTING IMAGE

(76) Inventors: Deok Gyu LEE, Daejeon (KR); Yun-Kyung LEE, Daejeon (KR); Geon Woo KIM, Daejeon (KR); Jong-Wook HAN, Daejeon (KR); Kyo Il CHUNG, Daejeon (KR); Jong Soo JANG, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/408,299

(22) Filed: Mar. 20, 2009

(30) Foreign Application Priority Data
Jul. 30, 2008 (KR) 10-2008-0074616

(51) Int. Cl. H04N 5/228; G06K 9/00

(52) U.S. Cl. 348/222.1; 382/118

(57) ABSTRACT

An image protection apparatus includes an information collecting unit for collecting personally identifiable information to be embedded in images captured by an image capturing instrument; and an information processing unit for extracting personal information from the collected personally identifiable information. Further, the image protection apparatus includes an information embedding unit for embedding the extracted personal information into a captured image; and an image signaturing unit for writing a signature on the captured image by using the extracted personal information.

### CROSS-REFERENCE TO RELATED APPLICATIONS

The present invention claims priority of Korean Patent Application No. 10-2008-0074616, filed on Jul. 30, 2008, which is incorporated herein by reference.

### FIELD OF THE INVENTION

The present invention relates to image protection, and more particularly, to an image protection apparatus that embeds personal information and signature information in an image to thereby protect the image from others.

### BACKGROUND OF THE INVENTION

To prevent distribution of captured images without permission from the copyright owner, an existing video surveillance system, e.g., a CCTV system sends a captured image to a preset image information output unit to display to the user, or embeds information identifiable only to the copyright owner into various digital works such audio and video by using watermarking techniques.

Even an image embedded with a watermark can be output through an image information output unit connected to an image capturing unit such as a camcorder and camera, or can be transferred to another place, and hence can be viewed by others.

That is, in existing video surveillance systems, even images embedded with a watermark can be viewed by users or transmitted to other facilities. Hence, there is a problem that image information can be disclosed owing to illegal acts.

### SUMMARY OF THE INVENTION

In view of the above, the present invention provides an image protection apparatus that embeds personal information and signature information in an image to thereby protect the image from others.

In accordance with an embodiment of the present invention, there is provided an image protection apparatus including: an information collecting unit for collecting personally identifiable information to be embedded in images captured by an image capturing instrument; an information processing unit for extracting personal information from the collected personally identifiable information; an information embedding unit for embedding the extracted personal information into a captured image; and an image signaturing unit for writing a signature on the captured image by using the extracted personal information.

It is preferable that the information processing unit extracts device information of the image capturing instrument, and the information embedding unit embeds the device information into the captured image.

Further, it is preferable that the information embedding unit verifies validity of the extracted personal information in cooperation with an external personal information server through a network, and embeds the verified personal information in the captured image.

It is preferable that the information collecting unit collects personally identifiable information by using one or more method of image recognition barcode, personal identification tag, radio frequency identification (RFID), sensor, face recognition, and iris recognition.

It is preferable that the image signaturing unit writes signatures on frames in the captured image by using the personal information.

Further, it is preferable that the image signaturing unit writes signatures on each or parts of the units of preset number of frames in the captured images.

Furthermore, it is preferable that the information collecting unit and information processing unit are installed in the image capturing instrument, and the information embedding unit and image signaturing unit are installed in a server connected through a network to the image capturing instrument.

In a feature of the present invention, because both personal information and signature information are embedded in images, a user cannot identify an image of another user without validating relevant personal information and additionally access control is enforced on the administrator administrating the images.

When a particular case occurs, personal information embedded in an associated image can be used as digital evidence.

Further, because signature information are embedded into images in the form of various cryptographic signatures including public key certificates, particular types of facts such as place and time can be verified using the signature information. Therefore, illegal acts related to the images can be prevented before the fact, and legal measures can be taken after the fact as the image source and illegal act associated with the images can be identified.

### BRIEF DESCRIPTION OF THE DRAWINGS

The above and other features of the present invention will become apparent from the following description of embodiments, given in conjunction with the accompanying drawings, in which:

FIG. 1 is a block diagram of an image protection apparatus and related equipment in accordance with an embodiment of the present invention; and

FIG. 2 is a block diagram of an image protection apparatus and related equipment in accordance with another embodiment of the present invention.

### DETAILED DESCRIPTION OF THE EMBODIMENTS

Hereinafter, embodiments of the present invention will be described in detail with reference to the accompanying drawings which form a part hereof.

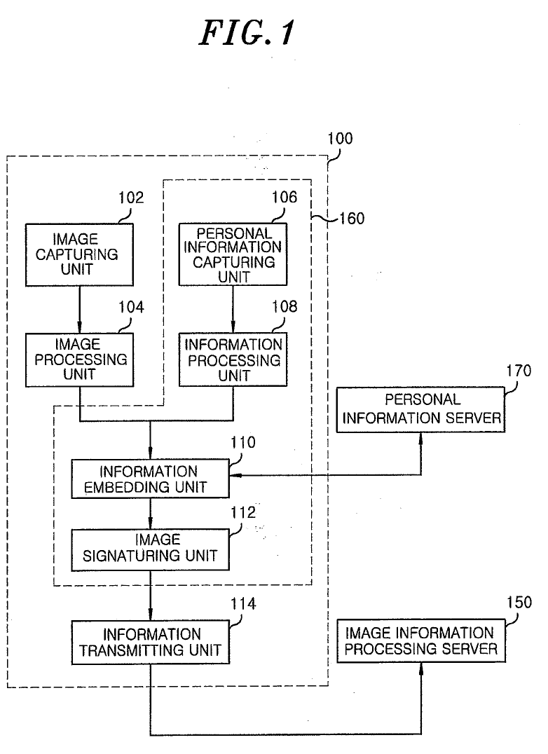

FIG. 1 is a block diagram of an image protection apparatus and related equipment in accordance with an embodiment of the present invention. As illustrated in FIG. 1, the image protection apparatus 160 and related equipments include an image capturing instrument 100, image information processing server 150, and personal information server 170. In this embodiment, the image protection apparatus 160 for protecting captured images is contained in the image capturing instrument 100.

The image capturing instrument 100 includes an image capturing unit 102, an image processing unit 104, an image protection unit 160 and image transmitting unit 114.

Further, the image protection unit 160 includes personal information collecting unit 106, information processing unit 108, information embedding unit 110 and image signaturing unit 112.

The image capturing unit 102 captures an image using a CCTV or image sensor. The image processing unit 104 performs signal processing related to objects and things in the captured image. The signal-processed image is provided to the information embedding unit 110.

The personal information collecting unit 106 collects personally identifiable information by using image recognition barcode, personal identification tag, RFID, sensor, face recognition and iris recognition, and sends the collected personally identifiable information to the information processing unit 108.

The information processing unit 108 extracts personal information from the collected personally identifiable information, also extracts device information, e.g., the serial number) of the image capturing instrument 100, and sends the extracted personal information and device information to the information embedding unit 110.

The information embedding unit 110 embeds the personal information and device information from the information processing unit 108 into a captured image. Here, to verify validity of the personal information, the information embedding unit 110 sends the personal information to the personal information server 170 connected through a network (not shown), and embeds the personal information in a captured image after verification.

The information embedding unit 110 can further embed the shot date and time information and the like in the captured image.

The image signaturing unit 112 writes a signature on the captured image on the basis of the embedded personal information by using various cryptographic schemes. Here, a public key-based signature is exemplified as signature writing.

That is, the image signaturing unit 112 writes a signature for frames in an image by using personal information, and preferably writes a signature not on consecutive frames in the image but on each or parts of the units of preset number of frames in the image.

The image signaturing unit 112 preferably writes a signature to an object, e.g., a human in an image by using personal information.

The image transmitting unit 114 sends an image embedding device information, written by the image signaturing unit 112, to the image information processing server 150.

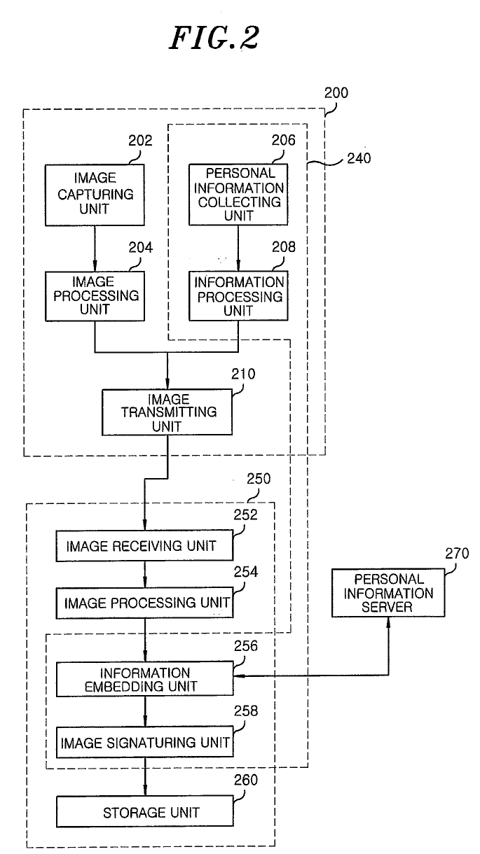

FIG. 2 is a block diagram of an image protection apparatus and related equipment in accordance with another embodiment of the present invention. As shown in FIG. 2, the image protection apparatus 240 and related equipments include an image capturing instrument 200, image information processing server 250, and personal information server 270. In this embodiment, the image capturing instrument 200 collects personal information and/or device information and sends the collected information to the image information processing server 250, which then writes a signature on a captured image and embeds the device information in the captured image using the personal information from the image capturing instrument 200.

In this embodiment, to reduce data processing load of the image capturing instrument 200, personal information and device information are just collected by the image capturing instrument 200. Further, signature writing and embedding of the personal and device information in the image are performed by the image information processing server 250 connected through a network to the image capturing instrument 200.

The image capturing instrument 200 includes an image capturing unit 202, image processing unit 204, parts of the image protection apparatus 240 including personal information collecting unit 206 and information processing unit 208, and image transmitting unit 210.

The image capturing unit 202 captures an image by using a CCTV, an image sensor or the like. The image processing unit 204 performs signal processing related to objects and things in the captured image.

The personal information collecting unit 206 collects personally identifiable information by using image recognition barcode, personal identification tag, RFID, sensor, face recognition, iris recognition or the like and sends the collected personally identifiable information to the information processing unit 208.

The information processing unit 208 extracts personal information from the collected personally identifiable information, also extracts device information, e.g., the serial number of the image capturing instrument 200, and sends the extracted personal information and device information together with an image captured by the image capturing unit 202 to the image information processing server 250 through the image transmitting unit 210.

The image information processing server 250 includes an image receiving unit 252 receiving an image, personal information and device information from the image capturing instrument 200, an image processing unit 254, the rest parts of the image protection apparatus 240 including an information embedding unit 256 and an image signaturing unit 258, and a storage unit 260.

The image processing unit 254 processes image information from the image receiving unit 252 in a format suitable for the current service, and sends the processed image information to the information embedding unit 256.

The information embedding unit 256 embeds personal information and device information into a captured image. Here, in order to verify validity of the personal information, the information embedding unit 256 sends the personal information to the personal information server 270 connected through a network (not shown), and embeds the personal information in a captured image after the verification.

The image signaturing unit 258 writes a signature on the captured image on the basis of the embedded personal information by using various cryptographic schemes. Here, a public key-based signature may be exemplified as a signature writing.

That is, the image signaturing unit 258 creates a signature for frames in an image by using personal information, and preferably writes a signature not on consecutive frames in the image but on each or parts of the units of preset number of frames.

Further, the image signaturing unit 258 preferably writes a signature to an object in an image by using personal information.

The image embedding device information and a signature written by the image signaturing unit 258 is stored in the storage unit 260.

In accordance with embodiments of the present invention, personal information extracted from the personally identifiable information and signature information created by using the personal information are embedded in images So that a user cannot identify the images without validating relevant personal information. Accordingly, both user privacy and copyrights on the images can be protected.

While the invention has been shown and described with respect to the preferred embodiments, it will be understood by those skilled in the art that various changes and modifications may be made without departing from the scope of the invention as defined in the following claims.

What is claimed is:

1. An image protection apparatus comprising:
an information collecting unit for collecting personally identifiable information to be embedded in images captured by an image capturing instrument;
an information processing unit for extracting personal information from the collected personally identifiable information;
an information embedding unit for embedding the extracted personal information into a captured image; and
an image signaturing unit for writing a signature on the captured image by using the extracted personal information.

2. The image protection apparatus of claim 1, wherein the information processing unit extracts device information of the image capturing instrument, and the information embedding unit embeds the device information into the captured image.

3. The image protection apparatus of claim 1, wherein the information embedding unit verifies validity of the extracted personal information in cooperation with an external personal information server through a network, and embeds the verified personal information in the captured image.

4. The image protection apparatus of claim 1, wherein the information collecting unit collects personally identifiable information by using one or more method of image recognition barcode, personal identification tag, radio frequency identification (RFID), sensor, face recognition, and iris recognition.

5. The image protection apparatus of claim 1, wherein the image signaturing unit writes signatures on frames in the captured image by using the personal information.

6. The image protection apparatus of claim 1, wherein the image signaturing unit writes signatures on each or parts of the units of preset number of frames in the captured images.

7. The image protection apparatus of claim 1, wherein the information collecting unit and information processing unit are installed in the image capturing instrument, and the information embedding unit and image signaturing unit are installed in a server connected through a network to the image capturing instrument.
